(19) United States
(12) Patent Application Publication
(10) Pub. No.: US 2009/0070096 A1
(43) Pub. Date: Mar. 12, 2009

(54) Apparel or fabric with the functionality of human languages translation

(76) Inventors: Jianfei Ye, Hangzhou (CN); Shan Ye, Hangzhou (CN); Nicole Ye, Chapel Hill, NC (US); Jason Ye, Chapel Hill, NC (US)

Correspondence Address: JIANFEI YE;Suite 8-2-201, Wu Hua XiaoQu, Wen Yi Xi Road, Hangzhou, Zhejiang, 310012, CN

(21) Appl. No.: 12/077,127

(22) Filed: Mar. 18, 2008

(30) Foreign Application Priority Data
Sep. 10, 2007 (CN) 200720176676.1

(51) Int. Cl. G06F 17/28

(52) U.S. Cl. 704/2

(57) ABSTRACT

A type of invented article, which may refer to apparel or fabric products, can translate languages during a conversation without common language. The invention resolves the most common conversational translation needs and eliminates a burden of bringing a dictionary, or e-dictionary, or hiring an interpreter. The apparel is attached or printed a graphic pattern which includes multiple human language written words or characters that can mutually annotate and interpret each other, a user can finger-point those words in his language to spell the sentences he wish to speak out, similar with the process of typing on computer keyboard to spell a word. In parallel as other conversational partners may watch the neighboring annotation in another language(s) they understand then catch the meaning of sentences. The invented article here may refer to T-shirts (short sleeve T-shirts and long sleeve T-shirts), jacket, shirt, suits, muffler, underwear, glove, pants, coat, sweet, swimsuit, wearable woven fabric, wearable knitted fabric, leather or cloth bags, etc. all types as per common understandings. This invention is also about a method to construct a graphic pattern capable of language translation.

### BACKGROUND OF THE INVENTION

As this world becomes increasingly tight-linked, there is a soaring need from international travelers, overseas residents, as well as international events participators etc. to bridge the lingual gaps during the conversational communication occasion without a common language.

In the past, those traditional approaches to fulfill language translation needs are either to carry a dictionary, or a top-use phrase book, or an electronic dictionary, or just to hire a human interpreter etc.

The invention in this application is for use in languages translation during the occasion that the conversation partners do not have a common language. Just by wearing or carrying this invention related items, the user will be able to easily conduct conversational communication even when the conversational participators do not have a common language hence reduce the dependency on traditional language translational approaches.

### BRIEF SUMMARY OF THE INVENTION

This invention is about the apparel or fabric facilitating language translation during a conversational communication process without a common language. The invented article displays a lingual translation graphic pattern on a surface of said invented article. Said lingual translation graphic pattern comprises a plurality of lingual translation units each at least having a written word in Language-A neighboring a corresponding written synonym in Language-B; said written word in Language-A and said corresponding written synonym in Language-B in the same lingual translation unit mutually annotating each other for translation between Language-A and Language-B; said Language-A refers to any human language, said Language-B refers to any human language other than Language-A. The user of the invented article can finger-point those words of either Language-A or Language-B on pattern in turn to spell the sentences of either Language-A or Language-B, similar with the process of typing on computer keyboard to spell a word. In parallel because the conversation counterpart person may watch the neighboring annotation in counterpart's language(s) then they immediately catch the meaning of the spelled sentences. The languages on the apparel can be any kind of human languages and characters for example English, German or Braille. The invention will fulfill the most common communication needs during international events, oversea travels, international humanity rescue as well as any types of communication settings involving multiple languages conversation. Also it may help disabled persons, for example a deaf-muted person can communicate with regular people without using dactylology by wearing invented apparel.

### BRIEF DESCRIPTION OF THE SEVERAL VIEWS OF THE DRAWING

FIG. 1 exhibits two typical types of lingual translation units related with the invention;

FIG. 1-A is for English language speakers who travel in Chinese-lingual regions, the English word is placed as upside down for the purpose of wearer's easy reading.

FIG. 1-B is for Chinese language speakers who travel in English-lingual regions; the Chinese Character is placed as upside down for the purpose of wearer's easy reading.

FIG. 2 exhibits the whole drawing of the apparel related with this invention. This figure shows a typical T-shirt application case related with the invention. On the T-shirt shown in Graph 2, approx. fifty carefully-selected words in simplified-Chinese characters are printed in normal direction, to form the most common-use vocabulary for the occasion of international travels in mainly China, meanwhile each corresponding English synonyms of those Chinese words are printed upside down at neighboring position. The reason to print the English words upside down in this case, is to make the English-speaking wearer of this T-shirt easily read out the English words from the top then finger-points on them.

FIG. 3 exhibits the drawing of the apparel buckled with a lingual translation dictionary book.

### DETAILED DESCRIPTION OF THE INVENTION

This invention is about the apparel or fabric facilitating language translation during a conversational communication process without a common language.

A conversation between two persons without a common language happens all the time during international travel, oversea residence, international sporting events (such as Olympic Games, World Cup etc.), international political & social events (such as United Nation meetings, World Expo), international activities (such as humanity rescue, natural disaster rescue, overseas military actions), international tradeshow & exhibitions etc. etc. In addition, a conversation between two persons without a common language may also refer to the occasion that one of persons is disabled person without lingual capability, i.e. he is deaf-muted.

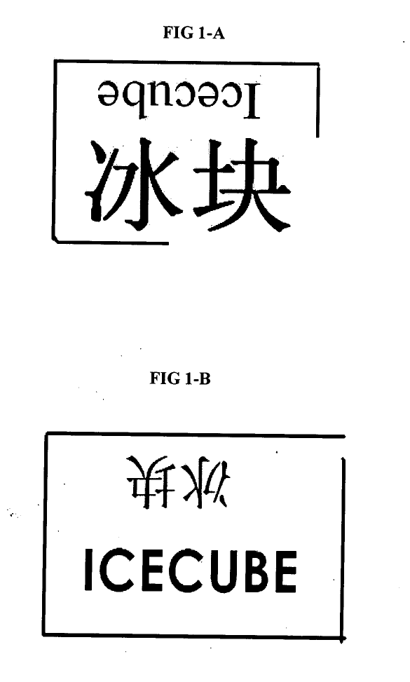

To build up a capability of language translation between at least two kinds of human languages, the invented article is attached with a graphic pattern which displays a set of words as a vocabulary in the language of the apparel wearer; this set of words is annotated by their respective corresponding synonyms of another foreign language that the counterpart foreigner in the conversation can understand. The word and its annotation in foreign language are neighboring each other to make up a lingual translation unit. FIG. 1 exhibits such lingual translation units.

In said graphic pattern attached, these lingual translation units are usually in scattered distribution, similar with the distribution of the key buttons on computer keyboard, rather than lining up into ready-made sentences.

Depending on the application occasions, such as travel or humanity rescue, the vocabulary usually picks top-use words for that occasion, to enable those lingual translation blocks have the maximum potential to be lined up into a variety of meaningful sentences to meet the communication needs of that occasion.

During a communication process involving the wearer and other conversation partners without common language, the wearer may use finger to point on these word-translating blocks in turn to spell the sentences of his (her) language, as what he(she)wishes to speak out. That process is similar with the process of typing on computer keyboard. Take example of a set of English words “I” “He” “Want” “Go” “Bathroom” “Airport” “Beer”, by finger-pointing in different turns, these words can spell many different meaningful sentences which are common-used for an English speaking traveler during oversea travels: i.e. I want go bathroom; I want go airport; He want (wants) go bathroom; He want (wants) go airport; I want beer; He want (wants) beer; I want he (him) go airport . . . etc.

In parallel with the spelling process, the wearer's conversational partner without common language may look at the finger-pointing path then naturally catch the meaning of sentences by understanding those neighboring annotations in the conversational partner's language.

The apparel here may refer to T-shirts (short sleeve T-shirts and long sleeve T-shirts), jacket, shirt, suits, muffler, underwear, glove, pants, coat, sweet, swimsuit, wearing woven fabric, wearing bags, wearing knitted fabric etc. all types based on common understandings.

Because short-sleeve T-shirt and long-sleeve T-shirt are the most portable apparel type, plus that it has large front and/or rear space to apply such a language-translating graphic pattern, the inventors predict that short-sleeve T-shirt and long-sleeve T-shirt will be the most common application of this invention.

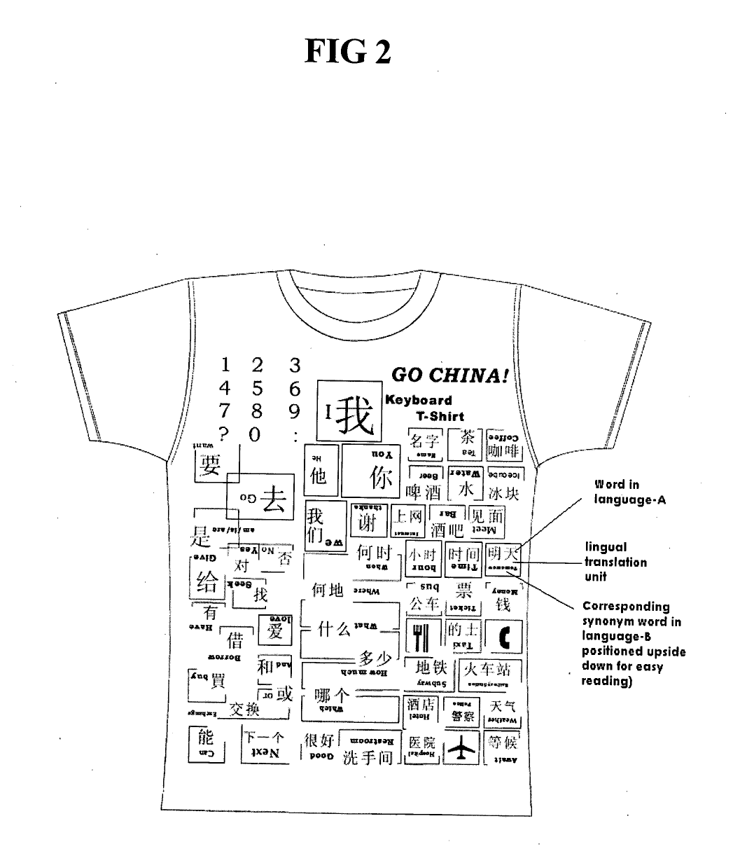

To better describe this invention, FIG. 2 gives a typical example on this invention related T-shirt: On the T-shirt shown in Graph 2, approx. fifty carefully-selected words in simplified- Chinese characters are printed in normal direction, to form the most common-use vocabulary for the occasion of international travels in mainly China, meanwhile each corresponding English synonyms of those Chinese words are printed upside down at neighboring position. The reason to print the English words here in upside down direction, is to make the English-speaking wearer of this T-shirt easily read out the English words from the top then finger-points on them.

Refer to the FIG. 2, when the T-shirt wearer finger-points on a series of English words to form sentence, for example the wearer finger-points on “when” “we” “meet” “?” four lingual translation units in turn, that process forms a sentence “when we meet?”. For a Chinese-speaking people who is the conversational partner to that English-speaking wearer, just needs watch those neighboring annotating Chinese words, then naturally catch the same meaning of “when we meet?” in Chinese.

When this Chinese speaks to the English-speaking T-shirt wearer back, it is a vice versa process to finger-point in turn on those Chinese words blocks first then they were translates in parallel into English.

In this example, for this specific design, calculated by math of permutation of these 50 words blocks in the vocabulary, may form more than 2000 sentences with a variety of meanings, to cover a significant portion of daily communication needs while an English speaker visits China, such as making friend, setting appointment, ordering food in local restaurant and bar, asking for road guidance, asking help during emergency etc.

Follow the same rule, if the English words above were annotated in Japanese rather than Chinese, then those sentences can be translated into Japanese, to facilitate the English speaker travel in Japan. If in Spanish, then that will be for travels in Spain and most of South America Countries.

Follow the same rule, if above Chinese words and English words mutually alter their positions, then the design will facilitate the translation needs of a Chinese people travels in English-speaking countries.

Follow the same thought, the design may refer to the combination of any normal human language, such as Thai, Japanese, Korean, Simplified-Chinese, Traditional-Chinese, Malay, Indonesian, Spanish, Deutsch, French, Portuguese, Italian, Swedish, Norwegian, Finland, Denmark, Nederland, Arabic, Hindi, Mongolian, Hebrew, Russian, Bengali, etc.;

These different language combinations may facilitate different translation needs, for example, such a T-shirt combined with French and Japanese vocabulary may facilitate the translation needs for a French people to travel in Japan, vice versa.

Follow the same thought, the invention may refer to the combination of special human languages (such as all types of Braille, man-made artificial languages etc.) and/or normal human languages.

Follow the same thought, in the design some visual symbols which have gained world wide recognition may replace the words, for example in the design the word “airport” can be replaced by a symbol of airplane, the symbol of Eiffel Tower replaces the word “Eiffel Tower”.

Follow the same thought, the combination might be more than two languages for translation, an exemplary case is to put corresponding English, Chinese and Japanese characters (words) in the neighboring position on the surface of a long sleeve T-shirt, only English in upside down direction, that combination enables the English-speaking wearer to travel to both Japan and China on the same piece of T-shirt.

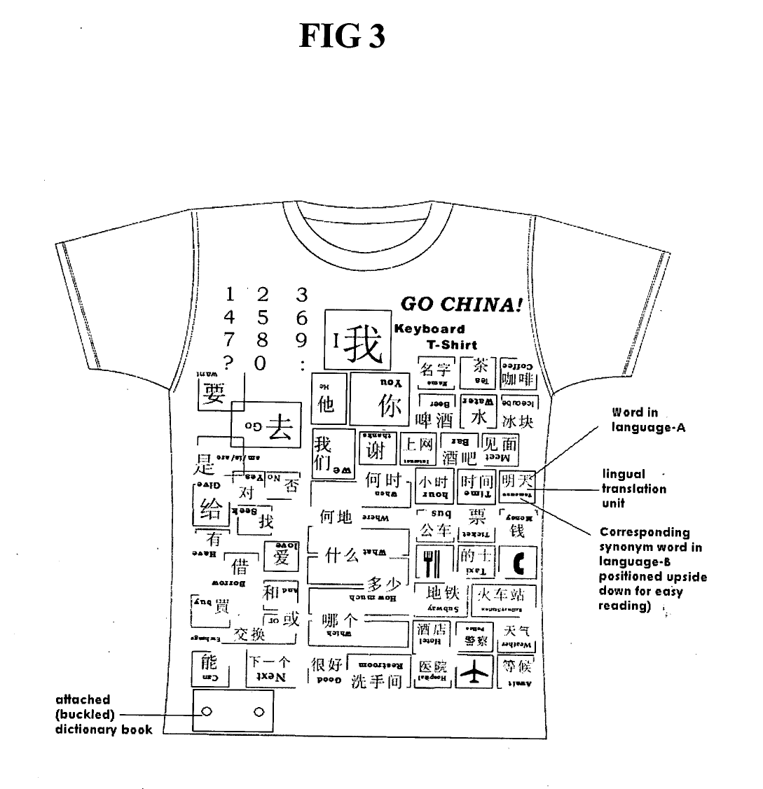

An extended type of this invention, is said apparel or fabric is also attached (buckled or sewed or pasted) with a dictionary book which is usually water-washable. FIG. 3 displays a typical example of that extended type.

The invented apparel in this application may refer to T-shirts (short sleeve T-shirts and long sleeve T-shirts), jacket, shirt, suits, muffler, underwear, glove, pants, coat, sweet, swimsuit, wearable woven fabric, wearable knitted fabric, leather or cloth bags, etc. all types as per common understandings.

1. Apparel for use in language translation, comprising a lingual translation pattern;
said lingual translation pattern displayed on a surface of said apparel;
said lingual translation pattern comprising a plurality of lingual translation units each at least having a written word in Language-A neighboring a corresponding written synonym word in Language-B;
said written word in Language-A and said corresponding written synonym in Language-B in the same lingual translation unit mutually annotating each other for translation between Language-A and Language-B;
said Language-A equaled to one of human languages, said Language-B equaled to one of human languages other than Language-A;
all of said written words in language-A making up a vocabulary capable of constructing a plurality of different sentences in language-A by selecting then permuting said written words in language-A;
all of said written synonym words in language-B making up a vocabulary capable of constructing a plurality of different sentences in language-B by selecting then permuting said written words in language-B;
at least a part of said plurality of lingual translation units displayed separately from one another in said lingual translation pattern to avoid forming ready-made sentences.

2. The apparel of claim 1, wherein said lingual translation pattern further comprise symbols.

3. The apparel of claim 1, wherein said lingual translation pattern further comprises images.

4. The apparel of claim 1, wherein said lingual translation pattern further comprises numbers.

5. The apparel of claim 1, wherein said lingual translation pattern further comprises logos.

6. The apparel of claim 1, wherein said lingual translation pattern further comprises decorating accessories.

7. The apparel of claim 1, wherein said lingual translation pattern further comprises some of symbols, numbers, images, logos, decorating accessories.

8. The apparel of claim 1, wherein the apparel further comprises lingual translation patterns displayed on more than one surface of said apparel.

9. The apparel of claim 1, wherein some of said lingual translation units in said lingual translation pattern are displayed in the form of ready-made sentences, at the same time the rest of said lingual translation units are displayed separately from one another to avoid forming ready-made sentences.

10. The apparel of claim 1, wherein said lingual translation pattern further comprises more types of human languages than said Language-A and said Language-B.

11. The apparel of claim 1, wherein said lingual translation pattern further comprises a language translation dictionary book attached with said apparel.

12. Fabric for use in language translation, comprising a lingual translation pattern;
said lingual translation pattern displayed on a surface of said fabric;
said lingual translation pattern comprising a plurality of lingual translation units each at least having a written word in Language-A neighboring a corresponding written synonym in Language-B;
said written word in Language-A and said corresponding written synonym in Language-B in the same lingual translation unit mutually annotating each other for translation between Language-A and Language-B;
said Language-A equaled to one of human languages, said Language-B equaled to one of human languages other than Language-A;
all of said written words in language-A making up a vocabulary capable of constructing a plurality of different sentences in language-A by selecting then permuting said written words in language-A;
all of said written synonym words in language-B making up a vocabulary capable of constructing a plurality of different sentences in language-B by selecting then permuting said written words in language-B;
at least a part of said plurality of lingual translation units exhibited separately from one another in said lingual translation pattern to avoid forming ready-made sentences.

13. The method of constructing graphic pattern capable of language translation between Language-A and Language-B, said Language-A equaled to one of human languages, said Language-B equaled to one of human languages other than Language-A;
said method comprising steps of:
selecting a plurality of words in Language-A to make up a vocabulary capable of constructing a plurality of different sentences in language-A by selecting then permuting said written words in language-A as per Math of Combination and Math of Permutation;
annotating each of said plurality of words in Language-A by corresponding synonym words of Language-B in respective neighboring position to form a plurality of lingual translation units; and
displaying said plurality of lingual translation units together but separately from one another to form a graphic pattern capable of translating a plurality of different sentences between Language-A and Language-B.
